(19) United States
(12) Patent Application Publication
(10) Pub. No.: US 2010/0211645 A1
(43) Pub. Date: Aug. 19, 2010

(54) IDENTIFICATION OF A TRUSTED MESSAGE SENDER WITH TRACEABLE RECEIPTS

(75) Inventors: Tak Yin Wang, Los Altos, CA (US); Leon Leytes, Mountain View, CA (US)

Correspondence Address: Yahoo! Inc.;c/o Frommer Lawrence & Haug LLP, 745 Fifth Avenue, NEW YORK, NY, 10151, US

(73) Assignee: Yahoo! Inc., Sunnyvale, CA (US)

(21) Appl. No.: 12/388,481

(22) Filed: Feb. 18, 2009

(51) Int. Cl. G06F 15/16; H04L 9/00

(52) U.S. Cl. 709/206; 713/154

(57) ABSTRACT

Embodiments are directed towards identifying trusted senders and their trusted sender accounts within a household network for use in at least managing spam activities. Primary trusted sender accounts are determined based on a traceable relationship between a network account and a known trusted source, such as a communication of qualified electronic statements. Coverage of trusted senders may be expanded by including other network accounts that might not receive qualified electronic statements but are detected as being owned by a primary trusted sender and/or their household members. The other household members being definable as secondary trusted senders with secondary trusted sender accounts. Various anti-spam filters and/or other activities may be modified based on the determined trusted sender status of a network account, including, minimizing an amount of spam analysis performed for a message, training of spam filters, or the like.

### TECHNICAL FIELD

The embodiments relate generally to managing messages over a network and, more particularly, but not exclusively to identifying trusted senders within a household of a primary trusted ‘message’ sender for use in managing spam detection activities, among other trust related activities.

### BACKGROUND

The problem of spam is well recognized in established communication technologies, such as electronic mail. Spam may include unsolicited messages sent by a computer over a network to a large number of recipients. Spam includes unsolicited commercial messages, but spam has come to be understood more broadly to additionally include unsolicited messages sent to a large number of recipients, and/or to a targeted user or targeted domain, for malicious, disruptive, or abusive purposes, regardless of commercial content. For example, a spammer might send messages in bulk to a particular user to harass, or otherwise, disrupt their computing resources.

While there are a large number of different anti-spam filters that are available to screen messages, unfortunately, many of them tend to produce an unacceptable level of false positives resulting in identifying messages improperly as spam. Many other anti-spam filters tend to insufficiently detect spam messages, resulting in allowing spam to be improperly delivered to a message recipient. Thus, it is with respect to these considerations and others that the present invention has been made.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding, reference will be made to the following Detailed Description, which is to be read in association with the accompanying drawings, wherein:

FIG. 1 is a system diagram of one embodiment of an environment in which embodiments of the invention may be practiced;

FIG. 2 shows one embodiment of a client device that may be included in a system implementing embodiments of the invention;

FIG. 3 shows one embodiment of a network device that may be included in a system implementing embodiments of the invention;

FIG. 4 illustrates a logical flow diagram generally showing one embodiment of a process for managing networking activities based on a determined set of secondary and primary trusted sender accounts; and

FIG. 5 illustrates a logical flow diagram generally showing one embodiment of a process for determining secondary trusted sender accounts within a household associated with a primary trusted sender account.

### DETAILED DESCRIPTION

The present invention now will be described more fully hereinafter with reference to the accompanying drawings, which form a part hereof, and which show, by way of illustration, specific embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. As used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “primary trusted sender account” refers to that network account for which a network communications is traceably received from a known trusted source. As used herein, the term “primary trusted sender” refers to a user associated with the primary trusted sender account. One such communication useable to identify the primary trusted account is based on which network account receives from the known trusted source, a qualified electronic statement, such as a billing statement, or the like, as described in more detail below. It may be possible that a primary trusted sender may be associated with multiple primary trusted sender accounts. It should also be noted that a primary trusted sender may be associated with a plurality of network accounts that do not receive communication from the known trusted source. Such plurality of “other” network accounts might be referred as “secondary trusted sender accounts,” where such network accounts are determined to be within a same household network, as defined further below. Secondary trusted sender accounts, however, may also be associated with users other than primary trusted senders. Such other users may be referred to herein as “secondary trusted senders.”

A network account refers to any established network relationship between a user and a computer and/or information service. Examples of network accounts include, but are not limited to Internet Service Provider (ISP) accounts; accounts established for use in sending messages over the network, including but not limited to email messages, Instant Messaging (IM) messages, Short Message Service (SMS) messages, internet relay chat (IRC) messages; service accounts, such as online dating services, search service accounts, financial services conducted over the network, blogger accounts, or the like.

The term “sender” refers to a user that sends a message over a network. It should be noted however, that the user might also receive messages over the network. Thus, the user may send and/or receive messages, and therefore, the term sender is not be construed as limiting the user to sending messages absent a possibility of also receiving messages.

The following briefly describes the embodiments of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, various embodiments are directed towards identifying trusted senders within a household network for use in managing spam activities, among other activities. Primary trusted sender accounts are determined based on a traceable relationship between a network account and a known trusted source.

A plurality of different known trusted sources may be identified that provide various types of qualified electronic statements to a network account. Because it is assumed that qualified electronic statements are sent to and paid by a real person, monitoring which network accounts receive and/or pay bills, invoices, or other qualified electronic statements, is expected to identify real persons. Moreover, because it is assumed that a spammer is unlikely to receive qualified electronic statements and/or pay bills, or other financial statements, through a network account created for spamming, network accounts that perform such financial transactions with known trusted sources may be considered primary trusted sender accounts, owned by primary trusted senders.

Trusted sources useable in monitoring for and/or identifying primary trusted sender accounts/senders might include any of a variety of sources for which a trust relationship may be established. Such sources include, but not limited to ISPs, utility entities, financial entities, telecommunications entities, cable/satellite service providers, selected merchants, and/or selected other service providers. The term “qualified electronic statement,” refers to a recurring or non-recurring request for payment from a known trusted source, and/or receipt for payment from a known trusted source. The term “qualified” as used above refers to using any of a variety of selection criteria to identify electronic statements from a trusted source.

As such, qualified electronic statements may include, but are not limited to a utility bill, a financial bill, an educational bill, a government bill, a purchase receipt, a telecommunications bill, such as a phone bill or the like, a subscription bill to such as a cable/satellite television service, or the like. Thus, qualified electronic statements include bills from known trusted sources, as well as receipts and/or financial notices from known trusted sources. Thus, for example, qualified electronic statements also includes recurring/non-recurring purchase receipts from known and trusted merchants, university enrollment confirmation notices, payroll deposit notifications, bank statements, credit card information, or even stock trading confirmation notices.

Coverage of trusted senders may be expanded to a household network by including other network accounts that might not receive qualified electronic statements that are owned by the primary trusted senders and/or their household members. The household members being identified as secondary trusted senders having secondary trusted sender accounts. As used herein, the term “household network” refers to those network accounts within a same network address or network addresses for which a two-way communications between the network account and the primary trusted sender account is detected. A household network may also be used to refer to the senders associated with the related network accounts within the same network address or network addresses for which a two-way communications is detected.

With trusted account/sender status established, various anti-spam filters and/or other activities may be modified to minimize workload, and/or provide a variety of benefits to the trusted senders. For example, in one embodiment, feedback from trusted sender accounts regarding whether a message is considered spam or non-spam might be given higher weight over feedback from a non-trusted sender account. Anti-spam filters might be modified to not analyze or other wise provide minimal analysis on messages sent from a trusted sender account. Similarly, anti-spam filters might be modified to not filter messages received from trusted sender accounts. In one embodiment, however, a recipient's white list on messages might still be applied. In one embodiment, messages from trusted sender accounts might be uniquely identified using, for example, a digital signature, or other mechanism, marking the message to be from a trusted sender account. Moreover, network accounts that are not associated with a household network of trusted senders, may be considered as being suspicious. As such, anti-spam resources may be re-directed towards identifying spam accounts more quickly over traditional mechanisms.

While information indicating that messages are from a trusted sender account may be employed to modify anti-spam filters, the invention is not so limited. For example, in other embodiments, trusted senders might be provided with improved services, discount rates, or the like, over non-trusted senders. For example, in one embodiment, a trusted sender's account might be provided larger file upload sizes, an allowance for sending bulk messages to a larger number of message recipients than might be allowed for a non-trusted sender, or the like.

As noted, embodiments are directed towards identifying trusted senders within a household network by tracing a primary trusted sender to qualified electronic statements. Such traceability to an actual person through the qualified electronic statements is expected to be more difficult to fake, than many other trust determination techniques traditionally suggested. This is at least because such activities usually involve real transactions from known trusted sources, typically over multiple, or recurring transmissions of qualified electronic statements.

Moreover, it should be recognized that identifying trusted senders within a household network provides an increased trust level capability over, for example, traditional social networks based on contact relationships. For example, in today's networking environment, many people may have over 100 contacts, where each contact may have several network accounts. Thus, using social network concepts, a person might have 200+ first degree of separation contacts. Extending to a second, third, or even fourth degree of separation for contacts may result in diminishing chances of ensuring that each contact is a real person. Moreover, traditional social networks, unlike household networks of network accounts, may not cover connections between household members or multiple network accounts owned by the same person. Thus, traditional social networks may cover a smaller percentage of accounts owned by a same sender, thereby resulting in missed network accounts, and thus, potentially missed trust level identifications.

### Illustrative Operating Environment

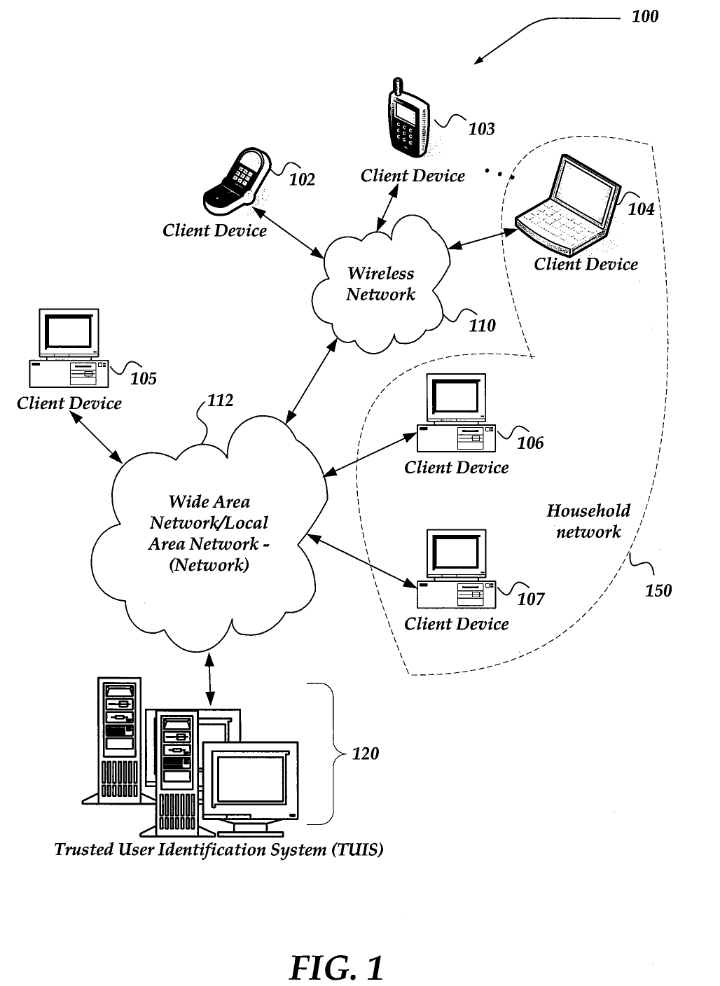

FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes local area networks (“LANs”)/wide area networks (“WANs”)—(network) 112, wireless network 110, client devices 102-107, and Trusted User Identification System (TUIS) 120.

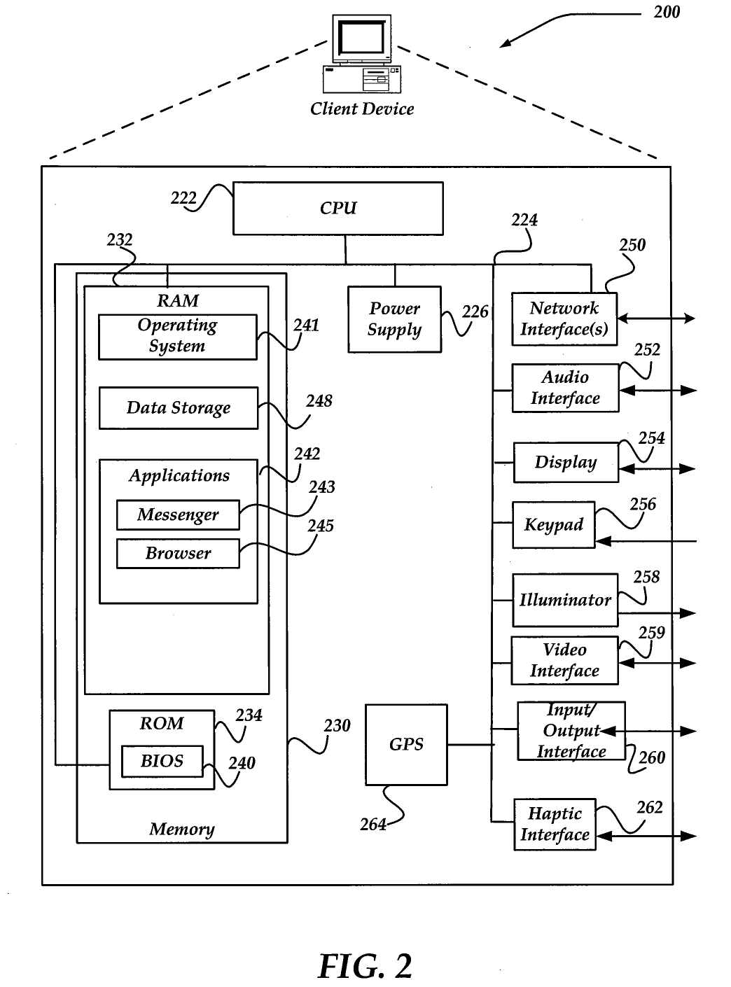

One embodiment of a client device usable as one of client devices 102-107 is described in more detail below in conjunction with FIG. 2. Generally, however, client devices 102-104 may include virtually any mobile computing device capable of receiving and sending a message over a network, such as wireless network 110, or the like. Such devices include portable devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, or the like. Client devices 105-107 may include virtually any computing device that typically connects using a wired communications medium such as personal computers, multiprocessor systems, microprocessor-based or programmable consumer electronics, network PCs, or the like. In one embodiment, one or more of client devices 102-107 may also be configured to operate over a wired and/or a wireless network.

Client devices 102-107 typically range widely in terms of capabilities and features. For example, a cell phone may have a numeric keypad and a few lines of monochrome LCD display on which only text may be displayed. In another example, a web-enabled client device may have a touch sensitive screen, a stylus, and several lines of color LCD display in which both text and graphics may be displayed.

A web-enabled client device may include a browser application that is configured to receive and to send web pages, web-based messages, or the like. The browser application may be configured to receive and display graphics, text, multimedia, or the like, employing virtually any web-based language, including a wireless application protocol messages (WAP), or the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), or the like, to display and send information.

Client devices 102-107 also may include at least one other client application that is configured to receive content from another computing device. The client application may include a capability to provide and receive textual content, multimedia information, or the like. The client application may further provide information that identifies itself, including a type, capability, name, or the like. In one embodiment, client devices 102-107 may uniquely identify themselves through any of a variety of mechanisms, including a phone number, Mobile Identification Number (MIN), an electronic serial number (ESN), mobile device identifier, network address, or other identifier. For example, the identifier might be an Internet Protocol (IP) network address, a Media Access Control (MAC) address associated with a gateway, router, or the like for the client device. The identifier may be provided in a message, or the like, sent to another computing device.

Client devices 102-107 may also be configured to communicate a message, such as through email, SMS, MMS, IM, IRC, mIRC, Jabber, or the like, between another computing device. However, the present invention is not limited to these message protocols, and virtually any other message protocol may be employed.

Client devices 102-107 may further be configured to include a client application that enables the user to log into a network account that may be managed by another computing device, such as TUIS 120, or the like. Such network account, for example, may be configured to enable the user to receive/send emails, IM messages, SMS messages, access selected web pages, or participate in any of a variety of other networking activities. However, managing of messages or otherwise participating in other networking activities may also be performed without logging into the network account, in one embodiment.

A user of client devices 102-107 may employ any of a variety of client applications to access content, read web pages, receive/send messages, or the like. In one embodiment, each of client devices 102-107 may include an application, or be associated with an application that resides on the client device or another network device, that is useable to filter received messages. In one embodiment, the message filter might reside remotely on a network server, such as TUIS 120, or the like. For example, in one embodiment, the filter might be within or managed by a spam manager. In one embodiment, client devices 102-107 may also employ one or more white lists, black lists, or the like, useable to filter messages sent to the client device.

One or more client devices may be associated with a same household network that employs a same network address or network addresses. Thus, as illustrated, client devices 104, and 106-107 are illustrated as within a same household network employing a same network address or addresses. However, it should be clear that other arrangements of client devices may also be used, and thus embodiments are not restricted to the arrangement illustrated.

Wireless network 110 is configured to couple client devices 102-104 with network 112. Wireless network 110 may include any of a variety of wireless sub-networks that may further overlay stand-alone ad-hoc networks, or the like, to provide an infrastructure-oriented connection for client devices 102-104. Such sub-networks may include mesh networks, Wireless LAN (WLAN) networks, cellular networks, or the like.

Wireless network 110 may further include an autonomous system of terminals, gateways, routers, or the like connected by wireless radio links, or the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G), 4th (4G) generation radio access for cellular systems, WLAN, Wireless Router (WR) mesh, or the like. Access technologies such as 2G, 2.5G, 3G, 4G, and future access networks may enable wide area coverage for client devices, such as client devices 102-104 with various degrees of mobility. For example, wireless network 110 may enable a radio connection through a radio network access such as Global System for Mobile communication (GSM), General Packet Radio Services (GPRS), Enhanced Data GSM Environment (EDGE), Wideband Code Division Multiple Access (WCDMA), Bluetooth, or the like. In essence, wireless network 110 may include virtually any wireless communication mechanism by which information may travel between client devices 102-104 and another computing device, network, or the like.

Network 112 is configured to couple TUIS 120, and client devices 105-107 with other computing devices, including through wireless network 110 to client devices 102-104. Network 112 is enabled to employ any form of computer readable media for communicating information from one electronic device to another. Also, network 112 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 112 includes any communication method by which information may travel between computing devices.

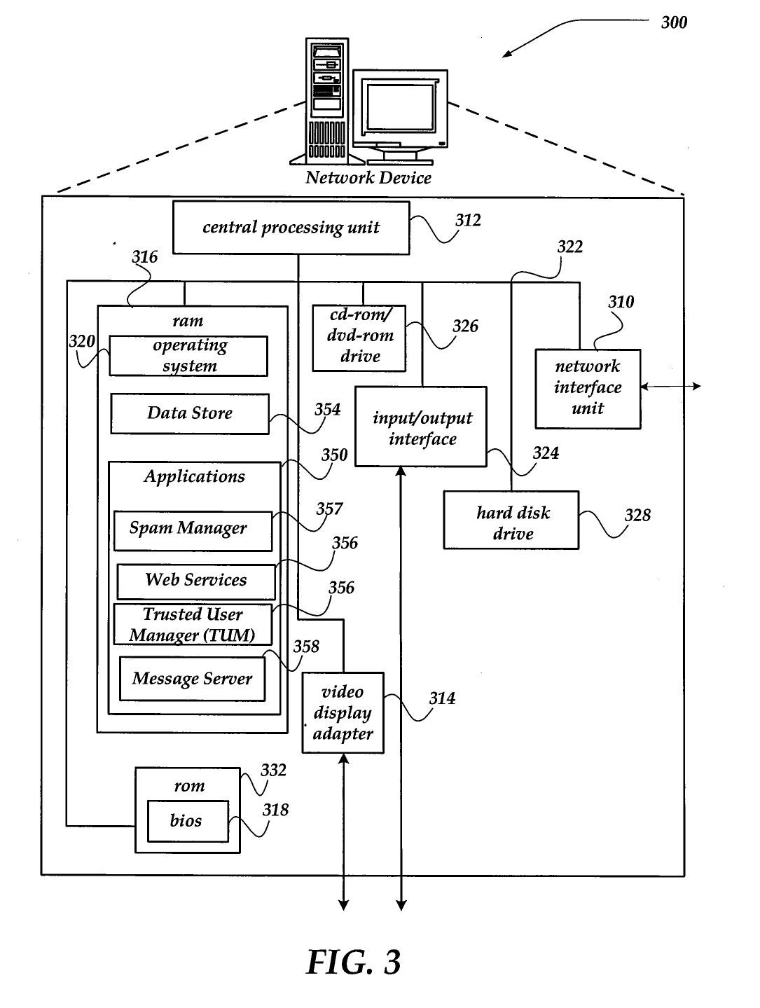

One embodiment of a network device configured as TUIS 120 is described in more detail below in conjunction with FIG. 3. As shown, TUIS 120 may include a plurality of network devices over which various operational aspects of TUIS 120 may be partitioned. Briefly, TUIS 120 represents one or more network devices that are configured to monitor activities of various network accounts to identify one or more accounts as primary trusted sender accounts. As noted above, a primary trusted sender account is typically associated with a single user or account owner, although various embodiments are not constrained to this configuration. In any event, in at least one embodiment then, a primary trusted sender account may be associated with a single message sender.

TUIS 120 may further identify a household network based on further monitored activities of the primary trusted sender account. TUIS 120 may further identify within the household network one or more secondary trusted accounts.

TUIS 120 may then employ the identified trust levels for various network accounts and senders to at least modify a spam filter based on the trust level to reduce a level of filtering of messages sent from the trusted sender accounts. TUIS 120 may also employ the identified trust levels to provide additional benefits to the trusted senders, increase a quality of anti-spam management, or the like. In one embodiment, the trust levels may be used for various other activities, including, but not limited to rating blog inputs, evaluating input ratings on movies, products, or the like.

Devices that may operate as TUIS 120 include, but are not limited to personal computers, desktop computers, multiprocessor systems, microprocessor-based or programmable consumer electronics, network PCs, servers, network appliances, and the like.

Although TUIS 120 is illustrated as a plurality of network devices, the invention is not so limited. For example, in one embodiment, a single network device may be configured to perform the operational aspects of TUIS 120.

### Illustrative Client Environment

FIG. 2 shows one embodiment of client device 200 that may be included in a system implementing the invention. Client device 200 may include many more or less components than those shown in FIG. 2. However, the components shown are sufficient to disclose an illustrative embodiment for practicing the present invention. Client device 200 may represent, for example, one of client devices 102-107 of FIG. 1.

As shown in the figure, client device 200 includes a processing unit (CPU) 222 in communication with a mass memory 230 via a bus 224. Client device 200 also includes a power supply 226, one or more network interfaces 250, an audio interface 252, video interface 259, a display 254, a keypad 256, an illuminator 258, an input/output interface 260, a haptic interface 262, and an optional global positioning systems (GPS) receiver 264. Power supply 226 provides power to client device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station (not shown), or directly with another computing device. Network interface 250 includes circuitry for coupling client device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth™, infrared, Wi-Fi, Zigbee, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Video interface 259 is arranged to capture video images, such as a still photo, a video segment, an infrared video, or the like. For example, video interface 259 may be coupled to a digital video camera, a web-camera, or the like. Video interface 259 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. In addition, illuminator 258 may backlight these buttons in various patterns when particular actions are performed, such as dialing another client device. Illuminator 258 may also cause light sources positioned within a transparent or translucent case of the client device to illuminate in response to actions.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth™, Wi-Fi, Zigbee, or the like. Haptic interface 262 is arranged to provide tactile feedback to a user of the client device. For example, the haptic interface may be employed to vibrate client device 200 in a particular way when another user of a computing device is calling.

Optional GPS transceiver 264 can determine the physical coordinates of client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of client device 200 on the surface of the Earth. It is understood that under different conditions, GPS transceiver 264 can determine a physical location within millimeters for client device 200; and in other cases, the determined physical location may be less precise, such as within a meter or significantly greater distances. In one embodiment, however, a client device may through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer readable storage media for storage of information such as computer readable instructions, data structures, program modules, or other data. Mass memory 230 stores a basic input/output system (“BIOS”) 240 for controlling low-level operation of client device 200. The mass memory also stores an operating system 241 for controlling the operation of client device 200. It will be appreciated that this component may include a general-purpose operating system such as a version of UNIX, or LINUX™, or a specialized client communication operating system such as Windows Mobile™, or the Symbian® operating system. The operating system may include, or interface with a Java virtual machine module that enables control of hardware components and/or operating system operations via Java application programs.

Memory 230 further includes one or more data storage 248, which can be utilized by client device 200 to store, among other things, applications 242 and/or other data. For example, data storage 248 may also be employed to store information that describes various capabilities of client device 200, as well as store an identifier. The information, including the identifier, may then be provided to another device based on any of a variety of events, including being sent as part of a header during a communication, sent upon request, or the like. In one embodiment, the identifier and/or other information about client device 200 might be provided automatically to another networked device, independent of a directed action to do so by a user of client device 200. Thus, in one embodiment, the identifier might be provided over the network transparent to the user.

Moreover, data storage 248 may also be employed to store personal information including but not limited to contact lists, personal preferences, data files, graphs, videos, or the like. Data storage 248 may further provide storage for network account information useable with one or more message addresses, message folders, or the like. Thus, data storage 248 may include various message storage capabilities to store and/or otherwise manage message folders, such as email folders for spam messages, ham messages, bulk messages, inbox messages, deleted messages, or the like. In one embodiment, data storage 248 may also store and/or otherwise manage message classification data from traditional anti-spam filters, or the like. Moreover, in one embodiment, data storage 248 may further store one or more white lists, black lists, or the like. In one embodiment, a white list might be configured for use in determining whether to allow a message sent to a message address to be delivered. For example, if a message sender's address is detected as being on the white list, the message from the message sender may be sent to the recipient. If the message sender's address is not on the white list, the message may be blocked from being sent to the recipient. However, messages from a sender whose message address is not on the white list might also be sent to a spam folder, specially tagged or otherwise identified as possibly spam.

In any event, at least a portion of the information that may be stored in data storage 248 may also be stored on a disk drive or other storage medium (not shown) within client device 200.

Applications 242 may include computer executable instructions which, when executed by client device 200, transmit, receive, and/or otherwise process messages (e.g., SMS, MMS, IM, email, and/or other messages), multimedia information, and enable telecommunication with another user of another client device. Other examples of application programs include calendars, browsers, email clients, IM applications, SMS applications, VOIP applications, contact managers, task managers, transcoders, database programs, word processing programs, security applications, spreadsheet programs, games, search programs, and so forth. Applications 242 may include, for example, messenger 243, and browser 245.

Browser 245 may include virtually any client application configured to receive and display graphics, text, multimedia, and the like, employing virtually any web based language. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. However, any of a variety of other web-based languages may also be employed. In one embodiment, a user of client device 200 might employ browser 245 to access a network account, including logging into and/or out of the network account, as well as performing a variety of other activities.

Messenger 243 may be configured to initiate and manage a messaging session using any of a variety of messaging communications including, but not limited to email, Short Message Service (SMS), Instant Message (IM), Multimedia Message Service (MMS), internet relay chat (IRC), mIRC, and the like. For example, in one embodiment, messenger 243 may be configured as an IM application, such as AOL Instant Messenger, Yahoo! Messenger, NET Messenger Server, ICQ, or the like. In one embodiment messenger 243 may be configured to include a mail user agent (MUA) such as Elm, Pine, MH, Outlook, Eudora, Mac Mail, Mozilla Thunderbird, gmail, or the like. In another embodiment, messenger 243 may be a client application that is configured to integrate and employ a variety of messaging protocols. In one embodiment, messenger 243 may employ various message boxes or folders to manage and/or store messages. In one embodiment, access to a messaging session using messenger 243 may be performed by logging a network account that is configured to provide access to messaging applications remote to client device 200.

### Illustrative Network Device

FIG. 3 shows one embodiment of network device 300 that may be included in a system implementing the invention. Client device 300 may include many more or less components than those shown in FIG. 3. However, the components shown are sufficient to disclose an illustrative embodiment for practicing the present invention. Network device 300 may represent, for example, TUIS 120 of FIG. 1.

Network device 300 includes processing unit 312, video display adapter 314, and a mass memory, all in communication with each other via bus 322. The mass memory generally includes RAM 316, ROM 332, and one or more permanent mass storage devices, such as hard disk drive 328, tape drive, optical drive, and/or floppy disk drive. The mass memory stores operating system 320 for controlling the operation of network device 300. Any general-purpose operating system may be employed. Basic input/output system (“BIOS”) 318 is also provided for controlling the low-level operation of network device 300. As illustrated in FIG. 3, network device 300 also can communicate with the Internet, or some other communications network, via network interface unit 310, which is constructed for use with various communication protocols including the TCP/IP protocol. Network interface unit 310 is sometimes known as a transceiver, transceiving device, or network interface card (NIC).

The mass memory as described above illustrates another type of computer-readable media, namely computer storage media. Computer-readable storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other physical medium which can be used to store the desired information and which can be accessed by a computing device.

The mass memory also stores program code and data. For example, mass memory might include data store 354. Data store 354 may be include virtually any mechanism usable for store and managing data, including but not limited to a file, a folder, a document, or an application, such as a database, spreadsheet, or the like. However, data store 354 may also include other data or application storage and/or access mechanisms, including, but not limited to relational databases, post-relational data bases, object oriented data bases, cloud storage mechanisms, distributed storage mechanisms, or ‘peer to peer’ storage mechanisms. Thus, it should be clear that various embodiments are not constrained to any particular program code or data storage mechanism.

Data store 354 may manage information that might include, but is not limited to web pages, contact lists, identifiers, profile information, tags, labels, or the like, associated with a user, as well as scripts, applications, applets, and the like. Data store 354 may also store information identifying a trust level to a sender's network account, whether a network account is identified with a household network, or other related information usable to manage trust identification and/or spam management. Data store 354 may also store one or more folders, inboxes, or other devices useable for storing and managing messages.

One or more applications 350 may be loaded into mass memory and run on operating system 320. Examples of application programs may include transcoders, schedulers, calendars, database programs, word processing programs, HTTP programs, customizable user interface programs, IPSec applications, encryption programs, security programs, VPN programs, web servers, account management, and so forth. Applications 350 may include web services 356, Message Server (MS) 358, spam manager 357, and Trusted User Manager (TUM) 356.

Web services 356 represent any of a variety of services that are configured to provide content, including messages, over a network to another computing device. Thus, web services 356 include for example, a web server, messaging server, a File Transfer Protocol (FTP) server, a database server, a content server, or the like. Web services 356 may provide the content including messages over the network using any of a variety of formats, including, but not limited to WAP, HDML, WML, SMGL, HTML, XML, cHTML, xHTML, or the like. In one embodiment, web services 356 may interact with spam manager 357, TUM 356, and/or message server 358 with respect to message classification, and/or trust level determination.

Message server 358 may include virtually any computing component or components configured and arranged to forward messages from message user agents, and/or other message servers, or to deliver messages to a local message store, such as data store 354, or the like. Thus, message server 358 may include a message transfer manager to communicate a message employing any of a variety of email protocols, including, but not limited, to Simple Mail Transfer Protocol (SMTP), Post Office Protocol (POP), Internet Message Access Protocol (IMAP), NNTP, or the like. In one embodiment, access to a local message store, and/or messaging functions may be obtained via performing a login to a network account.

However, message server 358 is not constrained to email messages, and other messaging protocols may be managed by one or more components of message server 358. Thus, message server 358 may also be configured to manage SMS messages, IM, MMS, IRC, mIRC, or any of a variety of other message types.

Spam manager 357 is configured to include virtually any computing component that can receive a message and perform a classification of the message into at least spain or non-spam. Spam manager 357 may employ a variety of approaches to classify messages, including, but not limited to artificial intelligence approaches, various machine-learning algorithms, or the like. Non-exhaustive examples include Naïve Bayes, Support-Vector machines, logistic regression, perceptrons, Markovian discrimination approaches, neural networks, decision trees, or the like. Further, each of these algorithms may be employed different variations, such as regularization, feature weighting, or the like.

Spam manager 357 may also be configured to receive information about a trust level for a given message sender, and modify a level of message filtering based on the trust level for the message sender. For example, where the message may be determined to be sent by a primary trusted sender through a primary or secondary trusted sender account, then an amount of analysis might be reduced, or even by-passed. However, in one embodiment, spam manager 357 might still employ and honor a recipient's black list, white list, or the like.

In one embodiment, spam manager 357 might employ an increased weighting of feedback about whether a message is spam or not spam, if the feedback is received from a trusted sender versus a non-trusted sender. Moreover, such weighted feedback may be used to retrain aspects of spam manager 357. In addition, spam manager 357 might further receive information about whether a trusted sender/sender account is associated with spamming activity, or other abusive messaging activities. Spam manager 357 may then provide such information to TUM 356 for use in re-classifying a message sender trust status, and/or a trust status of other senders and/or their sender accounts within a same household network.

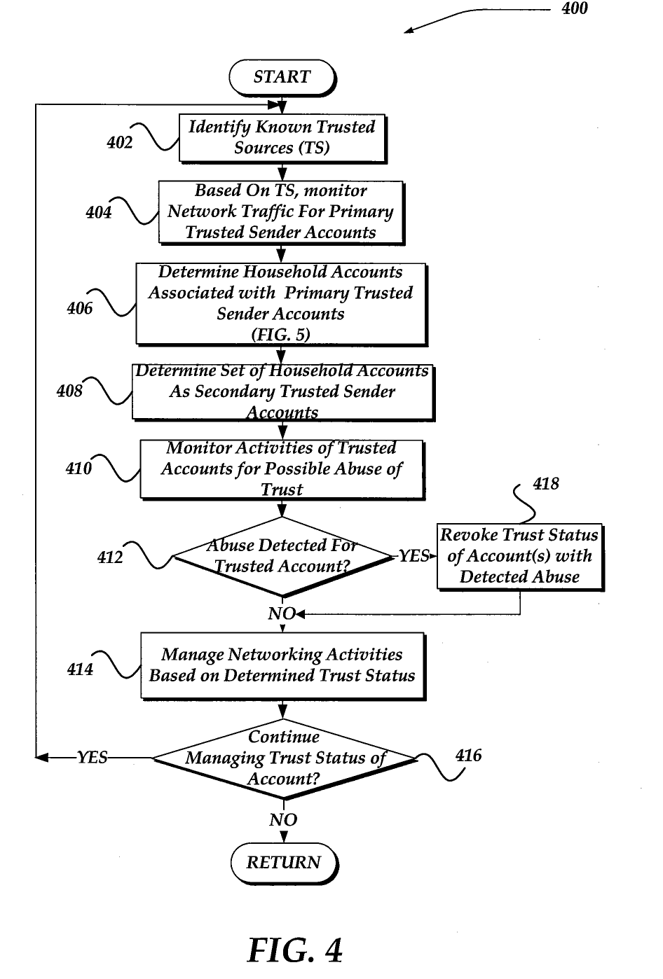

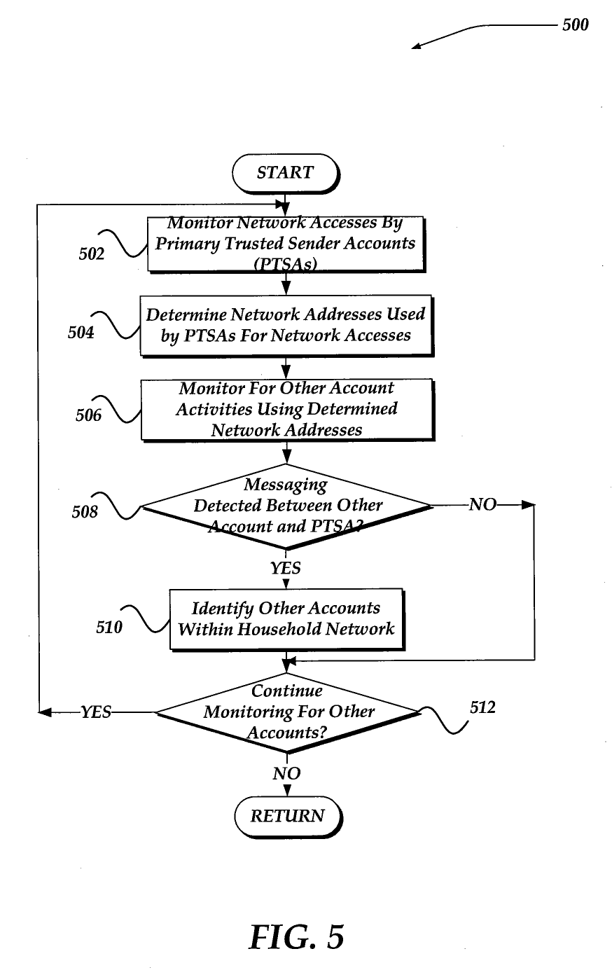

TUM 356 is configured to employ communications of qualified electronic statements with a known trusted source and another network address to identify primary trusted sender accounts and primary trusted senders. TUM 356 further identifies network addresses employed by the primary trusted sender accounts to expand the network accounts identified with a household network. Such additional network accounts may be defined as secondary trusted sender accounts. TUM 356 further provides such trust level classifications to spam manager 357 for use in managing at least anti-spam activities. TUM 356 may employ processes such as described below in conjunction with FIGS. 4-5 to perform at least some of its actions.

### Generalized Operation

The operation of certain aspects of the invention will now be described with respect to FIGS. 4-5. FIG. 4 illustrates a logical flow diagram generally showing one embodiment of a process for managing networking activities based on a determined set of secondary and primary trusted sender accounts. Process 400 may be implemented within TUIS 120 of FIG. 1, in one embodiment. However, process 400 may also be distributed across one or more client devices, network devices, or the like, in other embodiments.

Process 400 begins, after a start block, at block 402, where one or more known trusted sources for qualified electronic statements are identified. As noted above, qualified electronic statements may be obtained from a variety of sources. The qualified electronic statements may include those listed above, as well as utility bills, financial statements, wireless/landline phone bills, bills from selected subscriptions such as cable/satellite service providers, or the like. Qualified electronic statements may also be billing statements from selected merchants, and/or other service providers. Identification of the qualified electronic statements may be determined by establishing partnerships, and/or other relationships with various financial institutions, service providers, merchants, or the like, such that characteristics of their electronic statements, timing of sending the qualified electronic statements and other information may be obtained.

Because qualified electronic statements may be spoofed or otherwise faked, various mechanisms may be employed to determine whether the qualified electronic statements are from known trusted sources. For example, in one embodiment, a message header may be examined to determine a last network address, such as an IP address, or the like, that connects to a recipient's mail server, or other messaging server. Where a qualified electronic statement is determined to be associated with an expected domain name of the last network address for the known trusted source, the qualified electronic statement may be considered authentic and therefore “qualified.” Another mechanism for determining if the electronic statement is qualified might be to leverage various network domain verification technologies, and/or mail signing services, including, but not limited to domain keys (which is described in more detail in U.S. Pat. No. 6,986,049, entitled “Method and system for authenticating a message sender using domain keys,” issued Jan. 10, 2006); and/or Domain Keys Identified Mail (DKIM) (which is described in more detail in Request for Comments (RFC) 4871 available from the Internet Engineering Task Force (IETF)) (both of which are incorporated herein by reference in their entirety. The invention is not limited to these mechanisms, and other mechanisms may be used to qualify the electronic statement as coming from a known trusted source including, for example, Goodmail.

In one embodiment, identifying qualified electronic statements may be performed over a duration of time, such as monthly. This may be desirable in some situations, where the known trusted source typically provides qualified electronic statements on some periodic rate, such as monthly.

Processing moves next to block 404, where based on the identified known trusted sources, network traffic may be monitored to identify network accounts by which the qualified electronic statements is received. In general, typically, a spammer does not receive qualified electronic statements from a same network account for which they might employ to send spam messages. Thus, network accounts for which qualified electronic statements are received at, are more likely to be owned by a real person, rather than used by a spam robot (bot), or the like. Moreover, such network accounts are more likely to be owned by a person that may be trusted with respect at least to not sending spam or performing other fraudulent activities. Thus, monitoring for network accounts for which a qualified electronic statement is received, is likely to result in identifying network accounts that may then be said to be associated with primary trusted senders, with the network account then being deemed a primary trusted sender account. Such senders may be considered as primary, in the sense that they are the senders associated at a direct relationship with known trusted sources of the qualified electronic statements. Moreover, unless additional information so indicates, such senders are considered to be trusted.

Process 400 flows next to block 406, where coverage of trusted senders may be expanded by determining other network accounts that might be owned by the primary trusted sender and/or their household members. One embodiment of block 406 is described in more detail below in conjunction with FIG. 5. Briefly, however, at block 406, activities between the primary trusted sender's account and other network accounts within a definable set of network addresses is used to identify one or more network account within a household network of the primary trusted sender.

Moving to block 408, one or more of the network accounts within the household network accounts may be determined to be secondary trusted sender accounts. A subset may be selected for a variety of reasons. For example, in one embodiment, it may be determined that the set of household network accounts exceeds a defined maximum number of network accounts.

In one non-limiting example, consider that each person might have legitimately between three to seven different network accounts for which they send/receive messages. For example, a person might have an IM network account, an SMS network account, a blog network account, a personal email network account, a work email network account, or the like. If there are, for example, four members in the household, then the set of household network accounts could be between 12 to 28 different network accounts. Clearly, other households might have more or less network accounts. However, a maximum number may be selected based on various studies, historical data, survey results, or the like. In one non-limiting example, a maximum number might be set to between about 40 and about 60. Thus, if a household network is determined to have a number of household network accounts that exceed the defined maximum number, the household might be suspected as having network accounts for use in sending spam, and/or performing other activities, that might be deemed untrustworthy. As such, various actions may be taken. In one embodiment, a number of network accounts at or below the defined maximum number might be selected as secondary trusted sender accounts. In another embodiment, the secondary trusted sender accounts might be deemed those network accounts within the household network used by and/or registered by the primary trusted sender. Other variations of selection of network accounts may also be selected as secondary trusted sender accounts. For example, in one embodiment, only the original primary trusted sender account may be retained, and no secondary trusted sender accounts might be selected at block 408.

In any event, processing then flows to block 410, where the trusted accounts (primary and/or secondary accounts) are monitored for abuse, including, but not limited to sending spam, and/or other fraudulent activities. Such abuse might be detected using a variety of mechanisms, including data collected from various anti-spam filters, feedback from recipients of messages from a trusted account, reporting records from one of the known trusted sources, or the like.

Processing moves to decision block 412, where a determination is made whether abuse is detected by one of the trusted accounts. If no abuse is detected, processing moves to block 414. However, if abuse is detected, processing flows to block 418, where the trust status of the trusted account identified with detectable abuse might have its trust status revoked. That is, the network sender and/or network account might be identified as a non-trusted network account/sender. In one embodiment, where the sender is identified, each network account associated with the sender may also be marked as non-trusted. In another embodiment, where the network account is associated with a primary trusted sender, each of the secondary sender network accounts might also be marked as non-trusted. However, other revocation policies may also be applied. In any event, processing then flows to block 414.

At block 414, the trusted network accounts may be used by service providers, anti-spam filters, or the like, potentially improve spam detection activities, as well as a variety of other activities. For example, knowing that a message is sent by a trusted sender account, anti-spam filtering may be minimized, or potentially even eliminated. Similarly, at a message recipient's side, messages received from a trusted sender account might by-pass most anti-spam filters. In one embodiment, however, a recipient's white list, black list, or the like, might still be honored. In another embodiment, messages sent by a trusted sender account could be digitally signed. The digital signature may then be used as a ‘trust seal,’ or the like.

In one embodiment, for example, network addresses associated with a household network of trusted senders might be saved and applied to different anti-spam filtering mechanisms, based on whether the trusted sender logs into and sends messages from the network addresses defined within their household network. Non-limiting examples, include, but are not limited to: if the message is from a trusted sender and from the sender's household network's defined network addresses, then the message may be delivered absent additional anti-spam filtering. If the message is from a trusted sender, however, but not from the sender's household network's defined network addresses, then anti-spam filtering may be applied, but offset by a score assigned for the trusted sender. Moreover, if the message is from a non-trusted sender, then all anti-spam filtering rules may be applied to the message. Thus, spam filters may be modified based on a trust level (trusted or non-trusted) assigned to the trusted sender accounts/senders to reduce a level of filtering on messages sent from the trusted sender accounts/senders, as well as other criteria.

However, use of trusted network accounts is not restricted to these examples, and other applications may employ such information. For example, feedback about a message, indicating the message as spam or non-spam from a trusted network account might be given more weight than feedback from a non-trusted network account. Special privileges might also be provided to trusted senders, including, but not limited to providing larger file upload rights, allowing trusted senders to send a message to a larger list of recipients, or the like.

In any event, processing may flow next to decision block 416, where a determination is made whether to continue managing trust status of network accounts. If so, processing loops back to block 402; otherwise, processing may return to a calling process to perform other actions.

FIG. 5 illustrates a logical flow diagram generally showing one embodiment of a process for determining secondary trusted sender accounts within a household associated with a primary trusted sender account. Process 500 of FIG. 5 may represent one embodiment of block 406 of FIG. 4. Thus, in one embodiment, process 500 may be implemented within TUIS 120 of FIG. 1.

As noted above, process 500 is directed towards identifying trusted senders and their network accounts by monitoring for other network accounts owned by the primary trusted sender and/or their household members. Thus, an initial action is to identify a household network and its related network address or addresses.

Therefore, process 500 begins, after a start block, at block 502, where login activity is monitored for the primary trusted sender to the primary trusted sender accounts. In one embodiment, the monitoring is performed during a particular time period, such as between about 5:00 PM to about 11:00 PM, local time. Other time periods may also be selected. However, it may be assumed that primary trusted senders typically are those individuals that work during the daytime, and therefore may be away from their home. Thus, monitoring might be performed during times when the primary trusted sender is assumed to be home.

Processing flows block 504, where one or more network addresses are determined based on the monitored activities of the primary trusted sender account. In one embodiment, the network address may be an Internet Protocol (IP) address. However, other network addresses may also be determined based on the monitoring. For example, a Media Access Control (MAC) address of a gateway, router, or other device might also be determined. In one embodiment, network addresses from a broadband service provider might be preferred over say, for example, dial-in network addresses. However, any of a variety of network addresses may be detected based on the monitored activities of the primary trusted sender account.

Having one or more network addresses, process 500 flows to block 506, where login and/or other related activities from other network accounts is monitored for. For example, the primary trusted sender might employ more than one network account. Thus, the monitoring might be performed to detect other network accounts for which the primary trusted sender might employ.

A variety of mechanisms may be used to detect the other network accounts used by the primary trusted sender. For example, because a user might logout of one network account and then fairly shortly thereafter, log into one or more other network accounts, one approach might include using a cookie to track activities from a same browser or other messaging application. For example, a cookie might be stored having a session identifier, or other information, at the sender's client device. Then network accounts using the same browser over a certain time period may be monitored. For example, network accounts that logout, and/or kill a browser/session immediately before the primary trusted sender account is logged into, might be recorded. Moreover, network accounts that are logged into right after the primary trusted sender account is logged out of and/or a browser/session is killed may also be recorded. In one embodiment, a time period of about one to two minutes might be used.

Moreover, other network accounts used within the household network of determined network addresses may also be identified. For example, during a given time period, such as evening hours, or the like, any additional network accounts that are detected as being logged into from the same network addresses may also be identified.

However, because it is possible that a network address will actually be used by close neighbors to the primary trusted sender, additional analysis to narrow the set of network accounts may be employed. One of a variety of mechanisms to detect senders with a same household network, therefore, may include additional monitoring to detect two-way communications between a primary network sender account and the other network accounts. Such two-way communications may provide a stronger indication of the senders being within the same household network. Thus, flowing to decision block 508, a determination may be made if the other network accounts have had a two-way communications with the primary trusted sender account. If so, processing flows to block 510; otherwise, processing flows to decision block 512.

At block 510, the detected other network account is considered to be within the same household network as the primary trusted sender. Therefore, the detected other network account is a candidate for being defined as a secondary trusted sender account. Process then flows to decision block 512.

At decision block 512, a determination is made whether to continue to monitor for other network accounts. If so, processing loops back to block 502; otherwise, processing may return to a calling process to perform other actions.

In one embodiment, process 500 may continue over a period of time, such as several days for a given primary trusted sender account. For example, in one embodiment, process 500 need not seek to identify secondary trusted sender and their accounts a first day that some accounts are connected with the primary trusted sender account. In one embodiment, a threshold of a defined number of days/nights may be set to a particular household network is monitored. In one embodiment, the monitoring might be performed on some nights, and not others. For example, a weekend activity might provide information that weekday activity might not provide.

Moreover, various embodiments of process 500 may also be employed to expand the identification of trusted senders and their network accounts. Thus, for every trusted sender account and/or sender, including secondary trusted senders, their own login/logout activities might be monitored to detect other secondary trusted sender accounts used by the same sender. As noted, repeat monitoring might be performed, to update the household network information as well as to establish a pattern, where multiple incidents of connection/communication might be desired to establish the secondary trusted sender status, or other trust status level.

Thus, by using embodiments of process 500 new network accounts created by a trusted sender in addition to their primary trusted sender account might be detected relatively quickly, perhaps within a few days of first use, and thereby be established as secondary trusted network accounts.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer-implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems that perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A network device, comprising:
a transceiver to send and receive data over a network; and
a processor that is operative to perform actions, comprising:
identifying a primary trusted sender account based on a traceable association with a known trusted source;
monitoring activities of the primary trusted sender account over the network to detect a household network associated with the primary trusted sender account;
monitoring interactions within the household network with the primary trusted sender account to identify a secondary trusted sender account within the same household network; and
modifying a spam filter based on a trust level assigned to the primary trusted sender account and the secondary trusted sender account to reduce a level of filtering on messages sent from the primary trusted sender account or the secondary trusted sender account.

2. The network device of claim 1, wherein the known trusted source is an identifiable source that includes at least one qualified electronic statement such as that from a utility billing source, a financial billing source, an educational billing source, a government billing source, a purchase receipt source, an educational enrollment source, a payroll deposit notification source, a stock trading confirmation source, or a telecommunications billing source.

3. The network device of claim 1, wherein monitoring activities of the primary trusted sender account further comprises:
monitoring a log-in to the primary trusted sender account within a defined time period; and
determining a network address associated with the login of the primary trusted sender account, the network address being useable to define the household network.

4. The network device of claim 1, wherein monitoring interactions within the household network with the primary trusted sender account to identify a secondary trusted sender account within the same household network further comprises, monitoring for other primary trusted sender accounts within the same household network accessed by a same message sender.

5. The network device of claim 1, wherein the processor is operative to perform other actions, comprising:
detecting activity associated with the primary trusted sender account that is determined to be associated with spam activity;
revoking a trust level of the primary trusted sender account such that additional filtering of subsequent messages from the primary trusted sender account is performed.

6. The network device of claim 1, wherein identifying a primary trusted sender account further comprises detecting a qualified electronic statement being received at network account, and identifying the network account as the primary trusted sender account.

7. A processor readable storage medium that includes data and instructions, wherein the execution of the instructions on a computing device by enabling actions, comprising:
monitoring a plurality of network accounts to identify a primary trusted sender account based on receipt of a qualified electronic statement from a known trusted source;
monitoring activities over the network of the primary trusted sender account to identify a household network of the primary trusted sender account;
monitoring interactions within the household network to identify at least one other network account as a secondary trusted sender account within the same household network; and
modifying at least an anti-spam filter to reduce a level of spam analysis over another network account performed on an outgoing message from the primary trusted sender account or the secondary trusted sender account.

8. The processor readable storage medium of claim 7, wherein monitoring activities over the network of the at least one primary trusted sender account to identify a household network of the primary trusted sender account further comprises monitoring a log-in on the primary trusted sender account to detect a network address at which the log-in is detected.

9. The processor readable storage medium of claim 7, wherein monitoring interactions within the household network further comprises monitoring a message communications between the primary trusted sender account and at least one other network account within household network.

10. The processor readable storage medium of claim 7, wherein execution of the instructions on the computing device enable actions, further comprising:
if a total of primary trusted sender accounts and secondary trusted sender accounts within a same household network exceeds a threshold;
deleting the monitored network accounts being identified as secondary trusted sender accounts.

11. The processor readable storage medium of claim 7, wherein execution of the instructions on the computing device enable actions, further comprising:
identifying additional primary trusted sender accounts within the same household network by monitoring for login activities using a same browser application.

12. The processor readable storage medium of claim 7, wherein execution of the instructions on the computing device enable actions, further comprising:
revoking a trusted sender account status for a primary trusted sender account or a secondary trusted sender account if a spam activity is detected for that trusted sender account.

13. The processor readable storage medium of claim 7, wherein the known trusted source is an identifiable source that includes at least one qualified electronic statement such as that from a utility billing source, a financial billing source, an educational billing source, a government billing source, a purchase receipt source, an educational enrollment source, a payroll deposit notification source, a stock trading confirmation source, or a telecommunications billing source.

14. A system for enabling a communications over a network, comprising:
a network device configured to perform actions, including:
monitoring a plurality of network accounts to identify a primary trusted sender account based on receipt of a qualified electronic statement from a known trusted source, wherein the primary trusted sender account is associated with a primary trusted sender;
monitoring activities over the network of the primary trusted sender account to identify a household network of the primary trusted sender account;
monitoring interactions within the household network to identify at least one other network account as a secondary trusted sender account within the same household network; and
a spam manager operating on a network device that is configured to perform actions, including modifying at least one anti-spam filter to reduce a level of spam analysis over another network account performed on an outgoing message from the primary trusted sender account or the secondary trusted sender account

15. The system of claim 14, wherein identifying a primary trusted sender account further comprises detecting a qualified electronic statement being received at network account, and identifying the network account as the primary trusted sender account.

16. The system of claim 14, wherein monitoring activities of the primary trusted sender account further comprises:
monitoring a log-in to the primary trusted sender account within a defined time period; and
determining a network address associated with the login of the primary trusted sender account, the network address being useable to define the household network.

17. The system of claim 14, wherein the known trusted source is an identifiable source that includes at least one qualified electronic statement such as that from a utility billing source, a financial billing source, an educational billing source, a government billing source, a purchase receipt source, an educational enrollment source, a payroll deposit notification source, a stock trading confirmation source, or a telecommunications billing source.

18. The system of claim 14, wherein modifying at least one anti-spam filter further comprises modifying the spam filter to not perform spam filtering on a message sent by the primary trusted sender account or the secondary trusted sender account.

19. The system of claim 14, wherein modifying the at least one anti-spam filter further comprises if a message is received from the primary trusted sender account or the secondary trusted sender account not performing an anti-spam analysis on the message.

20. The system of claim 14, wherein modifying the at least one anti-spam filter further comprises weighting feedback from at least one of the primary trusted sender account or the secondary trusted sender account higher than feedback from a non-trusted sender account, wherein the weighted feedback is employed to modify at least one anti-spam filter.
